(19) United States
(12) Patent Application Publication
(10) Pub. No.: US 2026/0219355 A1
(43) Pub. Date: Jul. 30, 2026

(54) SYSTEMS AND METHODS FOR POSITIONING AND NAVIGATING OBJECTS USING PHASE-SYNCHRONIZED NONLINEAR OSCILLATORS

(71) Applicant: A2 Labs, LLC, Arlington, VA (US)

(72) Inventors: Georgia CHEIMONA, Attica (GR); Alireza FAMILI, Arlington, VA (US); Ioannis KOMINIS, Athens (GR); Angelos STAVROU, Fairfax, VA (US)

(73) Assignee: A2 Labs, LLC, Arlington, VA (US)

(21) Appl. No.: 19/272,785

(22) Filed: Jul. 17, 2025

(30) Foreign Application Priority Data
Jan. 30, 2025 (EP) 25386008.4

(51) Int. Cl. G01S 5/06

(52) U.S. Cl. CPC G01S 5/06

(57) ABSTRACT

Systems and methods for positioning and navigating objects using phase-synchronized nonlinear oscillators are disclosed. The system includes oscillators to operate in a limit-cycle oscillatory mode. The system further includes pulse-emitting source for emitting periodic pulse sequence signal. The system further includes a processing unit to phase-lock each of oscillators to the periodic pulse sequence signal. The processing unit further extracts fundamental harmonic frequency from outputs of oscillators using bandpass filter. The processing unit further determines phase difference between outputs of oscillators based on fundamental harmonic frequency. The processing unit further computes differential time delay between oscillators based on phase difference. The processing unit further determines position of pulse-emitting source by converting time delays into relative spatial distance using predefined propagation velocity of periodic pulse sequence signal.

### PRIORITY

The present application claims priority under 35 U.S.C. 119 (a)-(d) to EP patent application Ser. No. 25/386,008.4, having a filing date of Jan. 30, 2025, the disclosure of which is hereby incorporated by reference in its entirety.

### TECHNICAL FIELD

This patent application is directed to positioning and timing systems and, more specifically, to systems and methods for positioning and navigating objects using phase-synchronized nonlinear oscillators.

### BACKGROUND

Typically, precise time measurement is foundational to a wide range of technological domains, including telecommunications, navigation, and scientific research. Some existing approaches for time measurement and synchronization often rely on oscillators that generate periodic signals. The oscillators, typically operating under linear assumptions or near-harmonic behavior, are limited in their ability to respond dynamically to complex stimuli or environmental variations. Although such oscillators are widely utilized in systems such as Global Positioning System (GPS) and telecommunications, their static nature and simplified models leads to significant inaccuracies under non-ideal conditions or in the presence of signal degradation.

Further, the dependency of modern positioning technologies on satellite-based systems introduces several critical limitations. For instance, systems such as Global Positioning System (GPS) suffer from signal attenuation and multi-path distortion in urban areas, underground locations, and other obstructed environments. These drawbacks impair the reliability and precision of timing and location data, which are crucial for safety-critical applications such as aviation, autonomous navigation, and emergency response. Efforts to overcome these limitations using inertial navigation or Wi-Fi-based solutions have led to increased system complexity and resource demands, often without properly compensating for the loss of GPS signals.

Additionally, while techniques such as phase reduction and averaging simplify the analysis of synchronization phenomena. However, the techniques such as phase reduction and averaging often fail to capture the complex transient dynamics exhibited by nonlinear oscillatory systems in real-world conditions. Further, synchronized nonlinear electronic oscillators have been traditionally employed in telecommunication applications, functioning as frequency dividers and radio-frequency transceivers. Furthermore, time-averaging in combination with slowly varying amplitude and phase-reduced models have been the main tools to study locking phenomena and determine approximately the resonance regions of almost harmonic oscillators.

Although, the concepts of isochrons, phase maps, and synchronization have been explored in mathematical biology and neuroscience, their application to electronic oscillator-based time measurement systems remains undisclosed. Further, the full potential of nonlinear oscillator dynamics, especially phase sensitivity and complex synchronization responses to external stimuli, has not yet been used in the context of high-precision time and positioning systems. Accordingly, a significant gap in existing technological solutions exists.

Therefore, there is a need for an improved system and method for positioning and navigating objects using phase-synchronized nonlinear oscillators to measure the time delay between two or more signals under well-defined conditions for phase-locking, thereby enabling high-precision positioning.

### BRIEF DESCRIPTION OF DRAWINGS

Features of the disclosed embodiments are illustrated by way of example and not limited in the following Figure(s), in which like numerals indicate like elements, in which:

FIG. 1 illustrates an example block diagram representation of a network environment capable of positioning and navigating objects using phase-synchronized nonlinear oscillators, according to an example.

FIG. 2 illustrates an example block diagram representation depicting a processing unit, such as shown in FIG. 1, capable of computing the time delay between two or more signals, according to an example.

FIG. 3 illustrates an example block diagram representation of a system, such as those shown in FIG. 1, for positioning and navigating objects using phase-synchronized nonlinear oscillators, according to an example.

FIG. 4 illustrates an example circuit diagram representation of a Colpitts oscillator, according to an example.

FIG. 5 illustrates an example graphical representation depicting an unperturbed and a perturbed limit cycle after one pulse and isochrons of the system, according to an example.

FIG. 6 illustrates an example graphical representation of a Phase Response Curve (PRC) and Phase Transition Curve (PTC) curves, according to an example.

FIG. 7 illustrates an example graphical representation of resonance diagram for the Colpitts oscillator, devil's staircase for moderate and strong forcing, according to an example.

FIG. 8 illustrates an example graphical representation of a circle map orbit, a cobweb plot, a limit cycle, and fixed point of the Poincare map derived from simulation of the system, and an output spectrum, according to an example.

FIG. 9 illustrates an example graphical representation of time series of the voltages in oscilloscope of the system, according to an example.

FIG. 10 illustrates an example flow diagram representation of a method for positioning and navigating objects using phase-synchronized nonlinear oscillators, according to an example.

Further, those skilled in the art will appreciate those elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, server, or computer-implemented system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Examples of the present disclosure provides a system and method for positioning and navigating objects using phase-synchronized nonlinear oscillators. The system includes a plurality of oscillators to operate in a limit-cycle oscillatory mode. Further, each of the plurality of oscillators are located at a plurality of spatial positions with respect to a pulse-emitting source. Furthermore, the pulse-emitting source is configured to emit a periodic pulse sequence signal. Furthermore, the periodic pulse sequence signal propagates to each of the plurality of oscillators with a respective time delay based on corresponding distances of the plurality of oscillators from the pulse-emitting source. Furthermore, the system includes a processing unit. The processing unit includes a synchronization unit to phase-lock each of the plurality of oscillators to the periodic pulse sequence signal. Furthermore, each of the plurality of oscillators includes a phase difference proportional to a time delay of the periodic pulse sequence signal. Furthermore, the processing unit includes a phase comparison unit which is operatively connected to the output of the plurality of oscillators. Furthermore, the phase comparison unit is configured to extract a fundamental harmonic frequency from outputs of the plurality of oscillators using a bandpass filter. Furthermore, the bandpass filter is centered at a frequency corresponding to a synchronized oscillator frequency. Furthermore, the phase comparison unit is configured to determine the phase difference between the outputs of the plurality of oscillators based on the extracted fundamental harmonic frequency. Furthermore, the processing unit includes a time delay computation unit which computes a differential time delay between the plurality of oscillators based on the determined phase difference. Furthermore, the time delay computation unit determines a position of the pulse-emitting source by converting the time delays into a relative spatial distance using a predefined propagation velocity of the periodic pulse sequence signal.

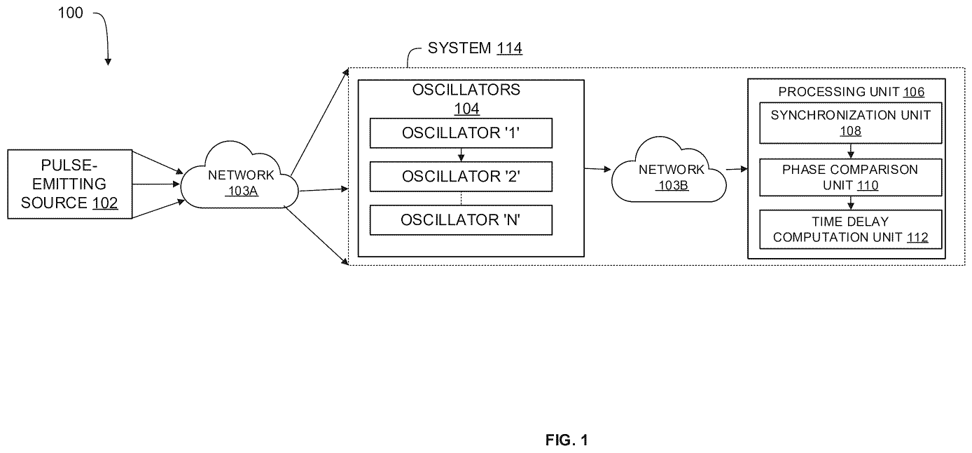

Referring now to the drawings, and more particularly to FIG. 1 through FIG. 10, where similar reference characters denote corresponding features consistently throughout the figures, there are shown preferred embodiments, and these embodiments are described in the context of the following example system and/or method.

FIG. 1 illustrates an example block diagram representation of a network environment 100 capable of positioning and navigating objects using phase-synchronized nonlinear oscillators. In some examples, the network environment 100 may include a pulse-emitting source 102, a plurality of oscillators 104 and a processing unit 106. The plurality of oscillators 104 may include oscillator ‘1’, oscillator ‘2’ up till oscillator ‘N’ (individually referred to as ‘oscillator 104’ and collectively referred to as ‘oscillators 104’). In an example, the plurality of oscillator 104 may generate a periodic signal, for example, but not limited to, a sine wave and a square wave. Further, the plurality of oscillators 104 may enable measurements of time intervals and frequency shifts in an accurate manner. Furthermore, the measurements of time intervals and frequency shifts enabled by the plurality of oscillators may be translated into precise positional information. In an example, the plurality of oscillators 104 may be used as a quartz crystal oscillator in interferometers. Furthermore, the quartz crystal oscillators may be used in laser interferometers such as but not limited to, in semiconductor manufacturing and metrology tools. Furthermore, a phase shift of the quartz crystal oscillator may be related to displacement of mirrors, allowing for sub-nanometer precision. Furthermore, the plurality of oscillators 104 may be used as a Surface Acoustic Wave (SAW) sensor. Furthermore, the SAW sensor may be used in devices, where the delay of acoustic waves changes with mechanical deformation. Furthermore, the plurality of oscillators 104 may be used as a resonant Micro-Electro-Mechanical Systems (MEMS) Sensor. Furthermore, the resonant MEMS sensor may incorporate oscillators whose resonance frequency shifts with position and load. Furthermore, the resonant MEMS sensor may be used in aerospace and biomedical devices for high-resolution inertial positioning.

Additionally, the plurality of oscillators 104 may operate in a limit-cycle oscillatory mode. Further, each of the plurality of oscillators 104 may be located at a plurality of spatial positions with respect to the pulse-emitting source 102. The pulse-emitting source 102 may emit a periodic pulse sequence signal. Furthermore, the periodic pulse sequence signal may propagate to each of the plurality of oscillators 104 with a respective time delay based on corresponding distances of the plurality of oscillators 104 from the pulse-emitting source 102.

In an example, the pulse-emitting source 102 may be a device, which may generate discrete, time-stamped pulses including but not limited to electrical, optical, and electromagnetic pulses. Further, in high-precision positioning applications, the pulse-emitting source 102 may be used to measure, including but not limited to, a time-of-flight (TOF) and a phase shift between emission and detection. This may enable extremely accurate calculation of, including but not limited to, a distance and a position of an object. In an example, the pulse emitting source 102 may be within the objects whose position is to be determined. Furthermore, the pulse-emitting source 102 may be used as a Light Detection and Ranging (Li-DAR). Furthermore, the Li-DAR may emit short laser pulses. Furthermore, the Li-DAR may measure a return time after reflecting off surfaces. Furthermore, the pulse-emitting source 102 in the form of the LiDAR may be applied to, including but not limited to, autonomous vehicles, topographic mapping, and industrial robotics. Furthermore, the pulse-emitting source 102 may be used as a Global Positioning System (GPS). Furthermore, the GPS may be used in a plurality of satellites, which may emit precise radio pulses with embedded time stamps. Furthermore, the pulse-emitting source 102 in the form of the GPS may be a receiver, which may calculate position by triangulating time delays from the plurality of satellites (not shown). Furthermore, the GPS may be applied to, including but not limited to, surveying and precision agriculture.

Additionally, the pulse-emitting source 102 may be communicatively coupled connected to the network 103A and the network 103A may be further connected to the plurality of oscillators 104. Further, the network 103A may be a wired or wireless digital communication medium. Furthermore, the network 103A may ensure at least one of an effective communication, a data integrity, and a real-time decision-making. Furthermore, the network 103A may be configured to perform a plurality of functions. Furthermore, the plurality of functions may include but not limited to a low-latency and a low-jitter transmission of synchronization pulses. Furthermore, the plurality of oscillators 104 may be communicatively connected to the network 103B. Furthermore, the network 103B may be further connected to the processing unit 106. Furthermore, the network 103B is a communication medium, which may facilitate bidirectional data exchange and synchronization between the plurality of oscillators 104 and the processing unit 106. Furthermore, the network 103B may be wired, or wireless networks. Wired networks include any of a wide variety of well-known means for coupling voice and data communications devices together. A brief discussion of various exemplary wireless network technologies that may be used to implement the embodiments of the present invention now are discussed. The examples are non-limited. Exemplary wireless network types may include, for example, but not limited to, code division multiple access (CDMA), spread spectrum wireless, orthogonal frequency division multiplexing (OFDM), 1G, 2G, 3G wireless, 4G, 5G or 6G, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), and the like.

Additionally, the network environment 100 may include the processing unit 106. In an example, the processing unit 106 may be defined as combination of a hardware and a software system, which may be responsible for receiving, analyzing, and interpreting signals from a plurality of sensors, including but not limited to the plurality of oscillators 104, and the pulse-emitting source 102 to compute accurate position, velocity, and orientation of the objects or the targets. In an example, the pulse emitting source 102 may itself be the object or the target.

Furthermore, the processing unit 106 may be used as, including but not limited to, a plurality of microcontrollers, a digital signal processor, a field-programmable gate array (FPGA) and an edge Artificial Intelligent (AI) processor. Furthermore, the plurality of microcontrollers may be used in compact embedded systems for real-time control. Furthermore, the digital signal processor may be optimized for fast mathematical operations on streaming data. Furthermore, the FPGA may offer high-speed parallel processing for real-time applications. Furthermore, the edge AI processor may combine neural networks and sensor fusion for intelligent positioning.

Additionally, the processing unit 106 may include a synchronization unit 108 to phase-lock each of the plurality of oscillators 104 to the periodic pulse sequence signal. Further, in an example, the synchronization unit 108 may be used for aligning time and data across the plurality of sensors and a plurality of signals to ensure coherent, accurate, and real-time positioning. Furthermore, the synchronization unit 108 may ensure that all time-dependent data including but not limited to a plurality of pulses, a plurality of oscillator signals, and a plurality of sensor outputs may be timestamped and processed in correct temporal order. Furthermore, the synchronization unit 108 may use various methods including but not limited to a precision time protocol method, a Global Navigation Satellite System (GNSS) time synchronization method, and a field-programmable gate array (FPGA)-based synchronization method. Furthermore, the precision time protocol method may be used in industrial and telecom applications for sub-microsecond synchronization. Furthermore, the GNSS time synchronization method may provide a common time reference for distributed systems including but not limited to a drone and an autonomous vehicle. Furthermore, the FGPA-based synchronization method may be used as a real-time synchronization in custom processing pipelines including but not limited to interferometry system.

Additionally, each of the plurality of oscillators 104 may include a phase difference proportional to a time delay of the periodic pulse sequence signal. Further, the network environment 100 may include a phase comparison unit 110 which may be operatively connected to the output of the plurality of oscillators 104. In an example, the phase comparison unit 110 may compare a phase difference between two periodic signals usually between a reference signal and a received signal to determine distance, displacement, and velocity with extremely high accuracy. Further, a signal including but not limited to sinusoidal signal and modulated signal may be transmitted. Furthermore, the signal may be then reflected and received from a target. Furthermore, the phase comparison unit 110 may be used to measure a phase shift between a transmitted and a received signal. Furthermore, the phase comparison unit 110 may be used to detect phase shift through measurement of an angle difference between a reference signal and the received signal. Furthermore, the phase comparison unit 110 may compute displacement through conversion of a phase difference into a linear displacement. Furthermore, the phase comparison unit 110 may track movement continuously through monitoring phase changes to track at least one of a movement and a vibration. Furthermore, the phase comparison unit 110 may provide real-time feedback to the processing unit 106 for at least one of control and correction. Furthermore, the phase comparison unit 110 may measure nanometer-scale displacements using an optical phase comparison.

Furthermore, the phase comparison unit 110 may be used in including but not limited to a semiconductor lithography, an Atomic Force Microscopy (AFM), and a precision machining. Furthermore, the phase comparison unit 110 may use phase differences to measure velocity and range in automotive radar and drones. Furthermore, the phase comparison unit 110 may be used in Surface Acoustic Wave (SAW) devices to monitor phase change in piezoelectric substrates for including but not limited to precision strain and displacement sensing.

Additionally, the phase comparison unit 110 may extract a fundamental harmonic frequency from outputs of the plurality of oscillators 104 using a bandpass filter (not illustrated in FIG. 1). Further, the bandpass filter may be centered at a frequency corresponding to a synchronized oscillator frequency. Furthermore, the phase comparison unit 110 may determine the phase difference between the outputs of the plurality of oscillators 104 based on the extracted fundamental harmonic frequency. Furthermore, the network environment 100 may include a time delay computation unit 112. Furthermore, the time delay computation unit 112 may compute a differential time delay between the plurality of oscillators 104 based on the determined phase difference. Furthermore, the time delay computation unit 112 may determine a position of the pulse-emitting source 102 by converting the time delays into a relative spatial distance using a predefined propagation velocity of the periodic pulse sequence signal.

In an example, the time delay computation unit 112 may measure time interval between emission and reception of a signal. Further, the signal may include but not limited to light, sound, and radio frequency. Furthermore, the time delay computation unit 112 may determine distance, displacement, and position of the object (also referred herein as ‘target’ or ‘a plurality of dynamic objects’) with high accuracy. Furthermore, the time delay computation unit 112 may measure Time-of-Flight (ToF) through calculation of travel time of emitted signals to the target and back. Furthermore, the time delay computation unit 112 may use a picosecond and a nanosecond-resolution timer and time-to-digital converters (TDCs). Furthermore, the time delay computation unit 112 may align emission and detection events through use of a synchronized system clock. Furthermore, the time delay computation unit 112 may continuously update position data for a plurality of dynamic objects.

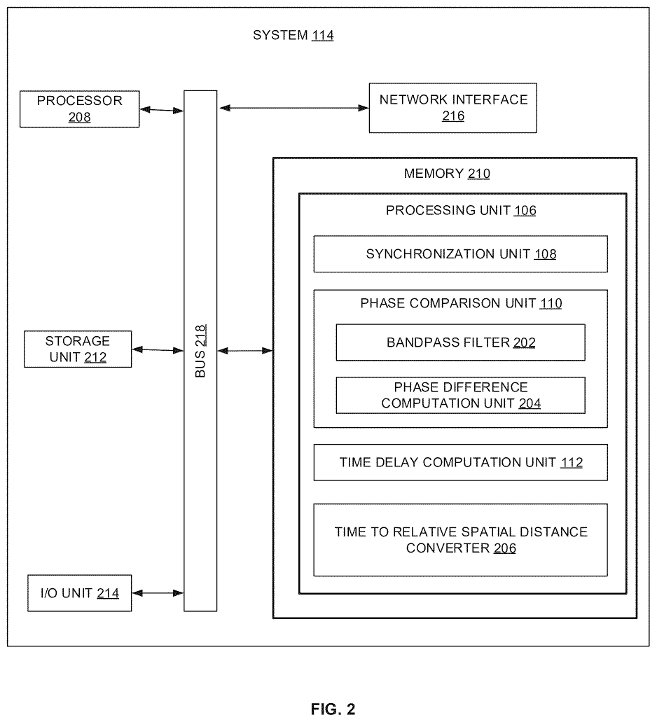

In one example, the oscillators 104 and the processing unit 106 may reside within a system 114. Alternatively, the oscillators 104 and the processing unit 106 may reside within two separate or standalone systems (not shown). A detailed overview of the system 114 is shown in FIG. 2.

While the processors, components, elements, systems, subsystems, and/or other computing devices may be shown as single components or elements, one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system, and components, as shown in FIG. 1.

It should be appreciated that the network environment 100 depicted in FIG. 1 may be a few example implementations. Hence, the network environment 100 may or may not include additional features and some of the features described herein may be removed and/or modified without departing from the scope of the network environment 100 outlined herein.

FIG. 2 illustrates an example block diagram representation depicting the processing unit 106, such as shown in FIG. 1, capable of computing the time delay between two or more signals, according to an example, according to an example. In a preferred example, the system 114 is shown as a standalone device comprising the processing unit 106. However, a person skilled in the art may envision that, the system 114 may alternatively also include the plurality of oscillators 104.

In an example, the system 114 may include a processor 208, a storage unit 212, an input/output (I/O) unit 214, a network interface 216 and a memory 210 operatively coupled with the processor 208 via a BUS 218. Further, the processor 208, the storage unit 212 and the I/O unit 214 may be communicatively connected to the BUS 218. Furthermore, the BUS 218 may be communicatively connected to the memory 210 and the network interface 216. Furthermore, the processor 208 may retrieve instructions from memory 210. Furthermore, the processor 208 may decode the instructions received from memory 210. Furthermore, the processor 208 may executes the instructions to control operation of the system 114. Furthermore, the processor 208 may handle, such as but not limited to, mathematical calculations, logic operations, and manage data flow between various components such as the memory 210, the I/O unit 214, and the network interface 216. Furthermore, the storage unit 212 may store data at least permanently and semi-permanently, such as but not limited to a hard drive (HDD), solid-state drive (SSD), or other non-volatile memory. Furthermore, the storage unit 212 may retain system software, application programs, configuration data, and user information. Furthermore, the storage unit 212 may provide long-term storage in contrast to the memory 210, which may be typically volatile and used for temporary, fast-access storage. Furthermore, the I/O unit 214 may interface with external devices, which may input data to and output data from the system 114. Furthermore, the I/O unit 214 may include interfaces such as but not limited to USB ports, keyboards, displays, sensors, or actuators. Furthermore, the I/O unit 214 may allow the system 114 to communicate with users and other systems, thereby facilitating data exchange and control signals. Furthermore, the BUS 218 may be a communication system, which may transfer data between internal components of a computer and between computers. Furthermore, the Bus 218 may serve as communication backbone of system 114, interconnecting the processor 208, the memory 210, the storage unit 212, the I/O unit 214, and the network interface 216. Furthermore, the BUS 218 may enable transfer of data, addresses, and control signals among the processor 208, the memory 210, the storage unit 212, the I/O unit 214, and the network interface 216. Furthermore, the network interface 216 may be hardware component for connecting the system 114 to a network, such as but not limited to a LAN, WAN, and the internet. Furthermore, the network interface 216 facilitates data exchange with at least one of external systems and remote servers over a network. Furthermore, the network interface 216 support protocols such as but not limited to Ethernet and wireless standards, enabling remote control, updates, and data transmission. Furthermore, the memory 210 may refers to volatile storage, typically RAM (Random Access Memory), which may temporarily hold data and instructions for quick access by the processor.

Additionally, the memory 210 may include processor-executable instructions in the form of the plurality of modules. Furthermore, the plurality of modules may include the processing unit 106. Furthermore, the processing unit may include the synchronization unit 108, the phase comparison unit 110, a time delay computation unit 112, and a time to relative spatial distance converter 206. Furthermore, the phase comparison unit 110 may include a bandpass filter 202 and the phase difference computation unit 204. Furthermore, the processor unit 106 may execute the plurality of modules to perform a plurality of steps described below.

In an example, the processing unit 106 may include the synchronization unit 108, the phase comparison unit 110, the time delay computation unit 112, and a time to relative spatial distance converter 206. Further, the phase comparison unit 110 may include the bandpass filter 202, and a phase difference computation unit 204. Furthermore, the phase comparison unit 110 may extract a fundamental harmonic frequency from outputs of the plurality of oscillators 104 using the bandpass filter 202. Furthermore, the bandpass filter 202 may be centered at a frequency corresponding to a synchronized oscillator frequency. Furthermore, the bandpass filter 202 may selectively pass signals within a desired frequency range, which may correspond to an operating frequency of the plurality of oscillators 104. Furthermore, the bandpass filter 202 may suppress a plurality of signals including but not limited to noise, harmonics, and unwanted frequency components falling beyond a range of the operating frequency. Furthermore, the bandpass filter 202 may reduce phase error by rejecting out-of-band noise and interference, which may be crucial in high-precision timing and positioning applications. Furthermore, the bandpass filter 202 may ensure to use fundamental frequency for the phase comparison unit 110. Furthermore, the bandpass filter 202 may enhance reliability of the phase comparison unit 110 by isolating relevant signal band, improving temporal resolution of the position sensing. Furthermore, the phase difference computation unit 204 may compute an average phase difference between more than two filtered oscillator signals, which may provide a direct measure of temporal shifts caused by physical displacement in a positioning sensor. Furthermore, the phase difference computation unit 204 may receive band-limited signals from at least one of an identical and a coupled nonlinear oscillator with phase relationship varying with position. Furthermore, the phase difference computation unit 204 may convert time-domain sinusoidal signals into phase-domain representations using techniques such as, including but not limited to zero-crossing detection, Hilbert transform, Phase-Locked Loops (PLLs) and arctangent demodulation. Furthermore, the phase difference computation unit 204 may determine the phase difference between the two signals received from the bandpass filter 202. Furthermore, the phase difference computation unit 204 may produce a digital and an analog signal corresponding to the computed phase difference correlating with the spatial displacement of a target. Furthermore, the time to relative spatial distance converter 206 may transform measured temporal information including but not limited to phase difference, frequency deviation and time delay obtained from the plurality of oscillators 104 into a relative physical displacement, based on a well-defined mathematical relationship between time and space in the system 114.

In an example, the synchronization unit 108 may determine phase-locking conditions of each of the plurality of oscillators 104 by deriving a phase response characteristic and a phase transition characteristic for each of the plurality of oscillators 104 using a mathematical model. Further, the mathematical model may define a limit cycle and isochrons in a state space of the plurality of oscillators 104. Furthermore, the synchronization unit 108 may evaluate synchronization parameters of each of the plurality of oscillators 104 based on the phase response characteristic to identify regions of phase-locking within a resonance diagram. Furthermore, the synchronization unit 108 may perform phase-locking to each of the plurality of oscillators 104 by iteratively aligning the phase of the plurality of oscillators 104 with the periodic pulse sequence signal using a circle map constructed from the phase response characteristic.

In an example, the phase response characteristic may include a phase response curve and a phase transition curve. Further, the phase response curve being continuous for moderate forcing. Furthermore, the phase response curve may provide a resulting phase difference in at least one of a delay and an advance. Additionally, the resulting phase difference may be due to an incoming pulse signal arrived at each of a specific phase of a free-running oscillator as a function of each of the specific phase. The phase transition curve may further provide at least one of a new phase and an altered phase as a function of each of the specific phase on which the incoming pulse may have arrived. In certain cases, a one-to-one relation between the incoming phase and the new phase may be there, which may allow for at least one of a sub-cycle time resolution and a sub-period time resolution.

In an example, each of the plurality of oscillators 104 may correspond to a Colpitts oscillator modelled by a nonlinear system of differential equations.

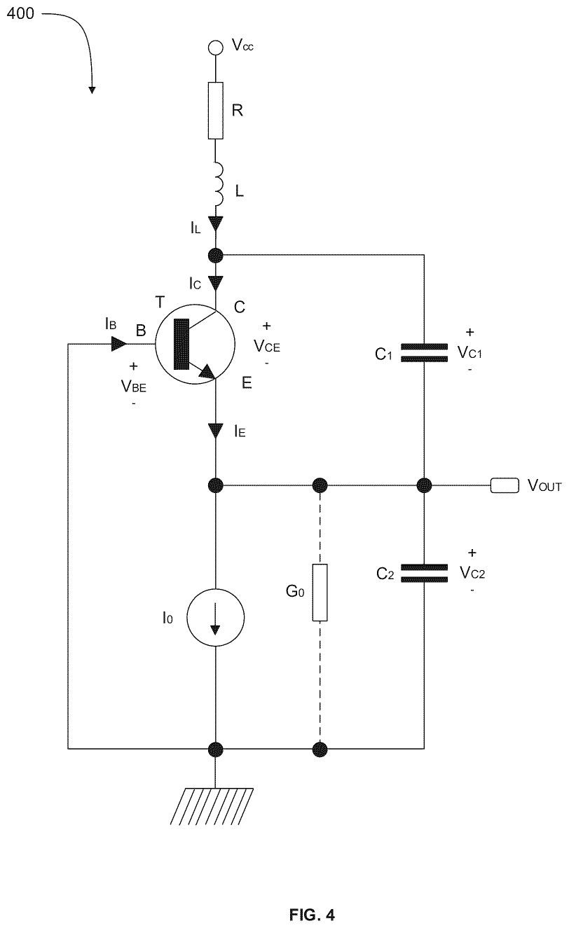

In an example, the Colpitts oscillator may include a time-dependent current source with a normalized amplitude connected in parallel with a constant current source, and a resistor for optimizing ohmic losses of an inductor (as shown in FIG. 4).

In an example, each Colpitts oscillator may include a transistor-based amplifier stage, a split capacitive voltage divider, and an inductive feedback loop forming an LC tank circuit (as shown in FIG. 4).

In an example, the periodic pulse sequence signal may include a sequence of rectangular pulses with a unitary amplitude, a pulse width proportional to a fraction of period of an unforced limit cycle of the plurality of oscillators 104, and a period defined as a multiple of the unforced limit cycle period adjusted by a fractional parameter.

In an example, the phase comparison unit 110 may compute complex Fourier coefficients at fundamental frequencies of each of the output of the oscillators 104 and calculate phase angle differences between each of the complex Fourier coefficients.

In an example, the time delay computation unit 112 may convert the determined phase difference into a time delay by scaling an angular difference by an inverse of a fundamental frequency corresponding to output of each oscillator.

In an example, the synchronization unit 108 may determine phase errors during synchronization by analyzing convergence of a phase trajectory of the oscillator 104 to a stable phase-locked state. Further, the synchronization unit 108 may select a measurement interval for synchronization based on the determined phase errors. Furthermore, the synchronization unit 108 may optimize oscillator parameters and periodic signal characteristics based on the selected measurement interval. The periodic signal characteristics may include, for example, a pulse amplitude, a duty cycle, and a frequency. Furthermore, the oscillator parameters may be the intrinsic properties of the plurality of oscillators 104, which may govern including but not limited to dynamic behavior, particularly limit-cycle oscillations, and response to external perturbations. Furthermore, for the Colpitts oscillator, the oscillator parameters may include a capacitive voltage divider ratio ‘K’, in the Colpitts circuit, which may influence the feedback strength. Furthermore, the oscillator parameters may include a quality factor ‘Q’, which may be associated with the cross-coupled resonant circuit (LC) oscillator, which may be known as an LC tank circuit, affecting the damping and resonance properties. Furthermore, the oscillator parameters may include a gain parameter ‘g’ which may be tied to the amplification of transistor, impacting the nonlinearity and oscillation amplitude of the plurality of oscillators 104. Furthermore, the oscillator parameters may determine the period of an unforced limit cycle (T), a stability of the limit cycle, and a phase response characteristic including but not limited to Phase Transition Curve (PTC) and Phase Response Curve (PRC) of the plurality of oscillators 104.

In an example, the synchronization unit 108 may adjust parameters of the periodic pulse sequence signal to remain within a synchronization region for phase-locking. Further, the parameters may include a pulse amplitude, a duty cycle, and a frequency.

In an example, the processing unit 106 may validate an oscillator model and a synchronization behavior of the oscillator model using a simulation environment. Further, the simulation environment may replicate real-world electrical conditions. Furthermore, the simulation environment may include non-ideal component characteristics including a parasitic resistance, a parasitic inductance, and a parasitic capacitance. Further, the simulation environment may be a virtual environment, depicting virtual instances of physical components or networks or connections. In an example, the simulation environment may be a digital twin based virtual model.

Execution of the machine-readable program instructions by the processing unit 106 may enable the synchronization unit 108 to perform one or more functions. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processing unit 106 may include, for example, microprocessors, microcomputers, microcontrollers, digital signal processors, central processing units, state machines, logic circuits, and/or any devices that manipulate data or signals based on operational instructions. Among other capabilities, the processing unit 106 may fetch and execute computer-readable instructions from the phase comparison unit 110 operationally coupled with the synchronization unit 108 for performing tasks such as data processing, input/output processing, attributes extraction, and/or any other functions. Any reference to a task in the present disclosure may refer to an operation being, or that may be, performed on data or input information.

In an example, interconnect terminal (not shown in FIG. 2) may interconnect various subsystems, elements, and/or components of the synchronization unit 108. Further, the interconnect may be an abstraction that may represent any one or more separate physical buses, point-to-point connections, or both, connected by appropriate bridges, adapters, or controllers. In some examples, the interconnect may include a system bus, a peripheral component interconnect (PCI) bus, or PCI-express (PCIe) bus, a hyper transport (HT) or industry standard architecture (ISA)) bus, a small computer system interface (SCSI) bus, a universal serial bus (USB), inter-integrated circuit (IIC or I2C) bus, or an institute of electrical and electronics engineers (IEEE) standard 1394 bus, or “firewire,” or other similar interconnection element.

In some examples, the interconnect may allow data communication between the processing unit 106 and the phase comparison unit 110, which may include read-only memory (ROM) or flash memory (neither shown), and random-access memory (RAM). It should be appreciated that the RAM may be the main memory into which an operating system and various application programs may be loaded. Further, ROM or flash memory may contain, among other code, the basic input-output system (BIOS) which controls basic hardware operation such as the interaction with one or more peripheral components.

In an example, the processing unit 106 may be the central processing unit (CPU) of the computing device and may control an overall operation of the system 114. In some examples, the processing unit 106 may accomplish this by executing software or firmware stored in system memory or other data via the storage. Further, the processing unit 106 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

In an example, the network environment 100 may refer to any apparatus, which may manipulate data using hardware and software. Further, the network environment 100 may include, but not limited to a processor, a memory, a storage and an input and output interface. Furthermore, the network environment 100 may execute a plurality of functions including but not limited to calculations, communication, and control. Furthermore, the network environment 100 may be available in numerous formats, ranging from personal computers and smartphones to specialized systems. Furthermore, the specialized systems may for example include but not limited to servers and supercomputers.

In an example, multimedia adapter (not shown in FIG. 2) may connect to various multimedia elements or peripherals. Furthermore, various multimedia elements or peripherals may include a device associated with visual (for example, video card or display), audio (for example, sound card or speakers), and/or various input/output interfaces (for example, mouse, keyboard, touchscreen).

Many other devices, components, elements, or subsystems (not shown) may be connected in a similar manner to the interconnect or via a network. Code or computer-readable instructions to implement the present disclosure may be stored in computer-readable storage media such as one or more of system memory or other storage. Code or computer-readable instructions to implement the present disclosure may also be received via one or more interfaces and stored in the memory 210.

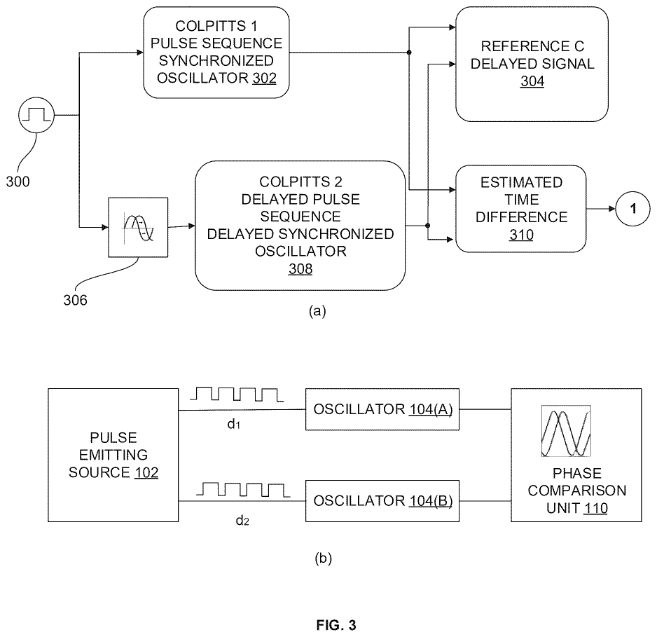

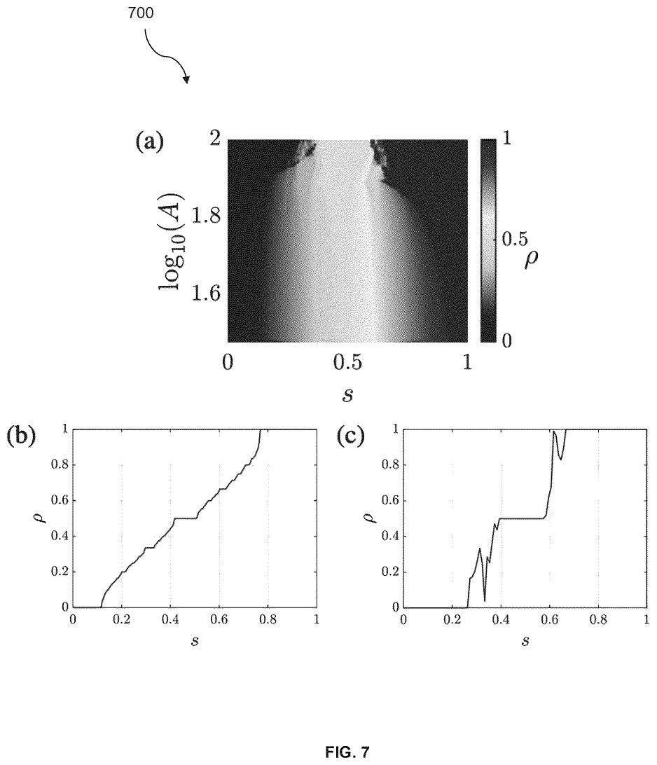

FIG. 3 illustrates an example block diagram representation of the system 114, such as those shown in FIG. 1, for positioning and navigating objects using phase-synchronized nonlinear oscillators, according to an example. According to part (a) of FIG. 3, the example flow diagram representation of the time delay measurement setup of the system 114 may be depicted. Further, a positioning scheme is based on the calculation of the time (interchangeably referred to as a phase) delay between two Colpitts oscillators. Furthermore, the two Colpitts oscillators include a Colpitts-1 Oscillator 302 and a Copitts-2 Oscillator 308. Furthermore, the Colpitts-1 Oscillator 302 and a Copitts-2 Oscillator 308 may be acted upon by a same periodic signal emitted by a source located at different distances from the plurality of oscillators 104. Furthermore, under appropriate conditions, while ensuring phase-locking, the two Colpitts oscillators namely, the Colpitts-1 oscillator 302 and the Colpitts oscillator-2 308, may have the same phase difference with respect to respective incoming periodic signals 300 and 306. Furthermore, the appropriate conditions may refer to an appropriate amplitude (A) and a time period (T_in) of the respective incoming periodic signals 300 and 306. The appropriate conditions may be readily provided by a calculated resonance diagram (as shown in part (a) of FIG. 7). Furthermore, the comparison of respective relative phases may directly provide a differential time of arrival between the two incoming signals. Therefore, the respective differential distance of the respective incoming periodic signals 300 and 306 may be calculated. Furthermore, the Colpitts-1 oscillator 302 may be used as a pulse sequence synchronized oscillator. Furthermore, the Colpitts-2 oscillator 308 may be used as a pulse sequence delayed synchronized oscillator. Furthermore, a reference signal may be obtained from the Colpitts-1 oscillator 302 and the delayed signal 304 may be obtained from the Colpitts-2 oscillator 308. Furthermore, an estimate of time difference 310 may be calculated by measurement of time delay between the two signals.

Additionally, FIG. 3 part (b) illustrates the block diagram depicting the time delay measurement setup of the system 114. Further, the pulse-emitting source 102 may emit the periodic pulse sequence signal d1 and d2. Furthermore, the periodic pulse sequence signal d1 and d2 may propagate to each of the plurality of oscillators 104 including an oscillator 104 (A) and an oscillator 104 (B) with a respective time delay based on corresponding distances of the plurality of oscillators 104 from the pulse-emitting source 102. Furthermore, the phase comparison unit 110 may be operatively connected to the output of the plurality of oscillators 104 including the oscillator 104 (A) and the oscillator 104 (B). Furthermore, the phase comparison unit 110 may extract a fundamental harmonic frequency from outputs of the plurality of oscillators 104 using a bandpass filter 202. Furthermore, the bandpass filter 202 may be centered at a frequency corresponding to a synchronized oscillator frequency. Furthermore, the phase comparison unit 110 may determine the phase difference between the outputs of the plurality of oscillators 104 based on the extracted fundamental harmonic frequency.

FIG. 4 illustrates an example circuit diagram representation 400 of a Colpitts oscillator 104, according to an example. Further, the phase locking of an electronic limit-cycle oscillator to an external periodic pulse sequence may depend crucially on the parameters of the free-running oscillator including the PRC and the PTC as well as on the characteristics of the external signal. Furthermore, a method of phase reduction may be applied to the Colpitts oscillator.

Furthermore, the method may be demonstrated by the utilization of a differential equation model of the system 114, as well as a conventional Simulink model with non-ideal parameters resembling an experimental set up. Furthermore, phase-locking conditions may be determined for the operation of more than two Colpitts oscillators. Furthermore, the Colpitts oscillators may be acted upon by the same periodic pulse sequence emitted by the same source. Furthermore, the same periodic pulse sequence may be arrived at each one of the Colpitts oscillators at different time moments due to different distances from the source. Furthermore, all oscillators 104 may be phase locked to the incoming periodic signal. However, a relative phase delay proportional to respective differential distance from the source may allow for precise positioning of a broadcasting object. Furthermore, the Colpitts oscillator 104 as illustrated in FIG. 4, may be described by a nonlinear system of differential equations depicted in equation 1.

$$\dot{x} = \frac{g}{Q ( 1 - K )} ( 1 - {e}^{- y} + z ) \qquad ( 1 )$$

$$\dot{y} = \frac{g}{Q K} ( z + A f ( t ) )$$

$$\dot{z} = - \frac{Q K ( 1 - K )}{g} ( x + y ) - \frac{1}{Q} z ,$$

Additionally, A may be the normalized amplitude of a time dependent current source i(t)=Alf(t) connected in parallel with the current source I. Further, the resistor R may account for the ohmic losses of the inductor including all other elements may be assumed ideal. Furthermore, the parameters K, Q, g in terms of the circuit elements may be given by an equation (2). The oscillator parameters may be defined by equation (2).

$$K = \frac{{C}_{1}}{{C}_{1} + {C}_{2}} , Q = \sqrt{\frac{L ( {C}_{1} + {C}_{2} )}{{RC}_{1} {C}_{2}}} , g = \frac{IL}{{V}_{T} R ( {C}_{1} + {C}_{2} )} \qquad ( 2 )$$

Additionally, the state variables maybe normalized voltages and current, respectively, expressed as by equation (3). Furthermore, the values of equation (3) may be calculated by using equation (4)

$$x = \frac{{v}_{C 1} - {v}_{C 1 , e q}}{{V}_{T}} \qquad ( 3 )$$

$$y = \frac{{v}_{C 2} - {v}_{C 2 , eq}}{{V}_{T}}$$

$$z = \frac{{i}_{L} - {i}_{L , e q}}{I}$$

$${v}_{C 1 , eq} = {V}_{c c} - RI - {V}_{T} ln ( \frac{{I}_{s}}{I} ) \qquad ( 4 )$$

$${v}_{C 2 , e q} = {V}_{T} ln ( \frac{{I}_{s}}{I} )$$

$${i}_{L , e q} = I$$

Additionally, f(t) in equation 1 may have the form of a periodic sequence of rectangular pulses as given by equation (5).

$$f ( t ) = {\sum }_{n = 0}^{∞} {\text{?}}_{[ 0 , {T}_{o n} )} ( t - n {T}_{in} ) \qquad ( 5 )$$

Further, [symbol] _{[0,T}_{ₒₙ}₎ may denote the rectangular pulse function of unitary amplitude and duration Tₒₙ. Furthermore, a pulse width of Tₒₙ=T/10 and a period Tᵢₙ=(k+s)T, k∈ [symbol] , s∈[0,1) may be considered. Furthermore, T may be the period of the unforced limit cycle.

Additionally, the parameters of the circuit elements and nonidealities may be depicted in Table I. Further, the parameters and nonidealities of transistor element may be depicted in Table II. Furthermore, although equation 1 may refer to the Colpitts oscillator, the respective conventional Simulink model takes into account non idealities of the system 114.

TABLE I
Circuit elements and nonidealities

| Element Parameter | Value | | Nonideality |
|---|---|---|---|
| Resistor R | 20Ω | | Tolerance ±1% |
| Inductor L | 0.12 | mH | Ohmic losses: R |
| Capacitors C₁ = C₂ | 0.8 | nF | Series resistance: 10⁻⁸Ω |
| Current Source I | 0.1 | mA | Finite parallel conductance |

| | | |
|---|---|---|
| Parameter log₁₀ g | 1.18 | Inherited |
| Parameter log₁₀ Q | 1.44 | Inherited |
| Parameter K | 0.5 | — |

TABLE II
Parameters and Nonidealities of Transistor

| | | |
|---|---|---|
| Transistor's parameters | Value | Nonideality |

| Saturation current I_{S} | 10⁻¹⁴ | A | — |
|---|---|---|---|
| Forward current transfer β | 100 | | Finite value |
| Forward Early voltage | 200 | V | Finite value |
| Base and emitter resistors | 10⁻⁴Ω | | Non-zero value |
| Parasitic capacitors ¹ | 0.1 | fF | Non-zero value |

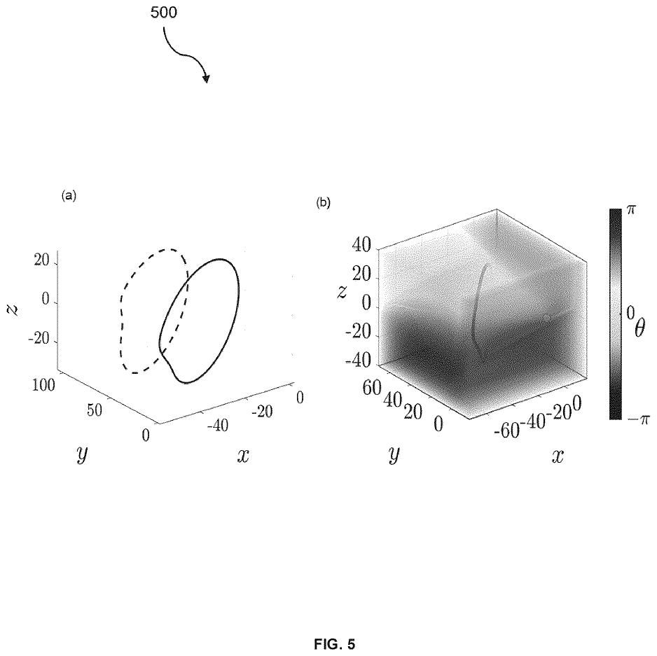

FIG. 5 illustrates an example graphical representation 500 depicting an unperturbed and a perturbed limit cycle after one pulse and isochrons of the system 114, according to an example. According to part (a) of FIG. 5, the unperturbed limit cycle (interchangeably referred to as a solid limit cycle) and perturbed limit cycle (interchangeably referred to as a dashed limit cycle) after one pulse with amplitude A=75. According to part (b) of FIG. 5 Isochrons may be depicted with parameter values log₁₀ g=1.18, log₁₀ Q=1.44, K=0.5. Further, the stable limit cycle of the Colpitts oscillator for a set of parameter values log₁₀ g=1.18, log₁₀ Q=1.44, K=0.5 has a period of T=1.37 μs and may be depicted in (a) of FIG. 5 along with the perturbed initial conditions after the action of a single rectangular pulse with amplitude A=75. Furthermore, the isochrons span the basin of attraction of the stable limit cycle including of the entire three-dimensional state space except from the unstable fixed point at the origin, as shown in part (b) of FIG. 5. Further, the computation has been performed with the utilization of Fourier averages evaluated on trajectories of the continuous-time ideal system. Furthermore, the computation may be performed by solving a system of ordinary differential equations as given in the equation (1) and calculating appropriate Fourier averages of resulting time-series. The computation may be performed once at the stage of designing the system 114. The computation may not be repeated when the system 114 operates.

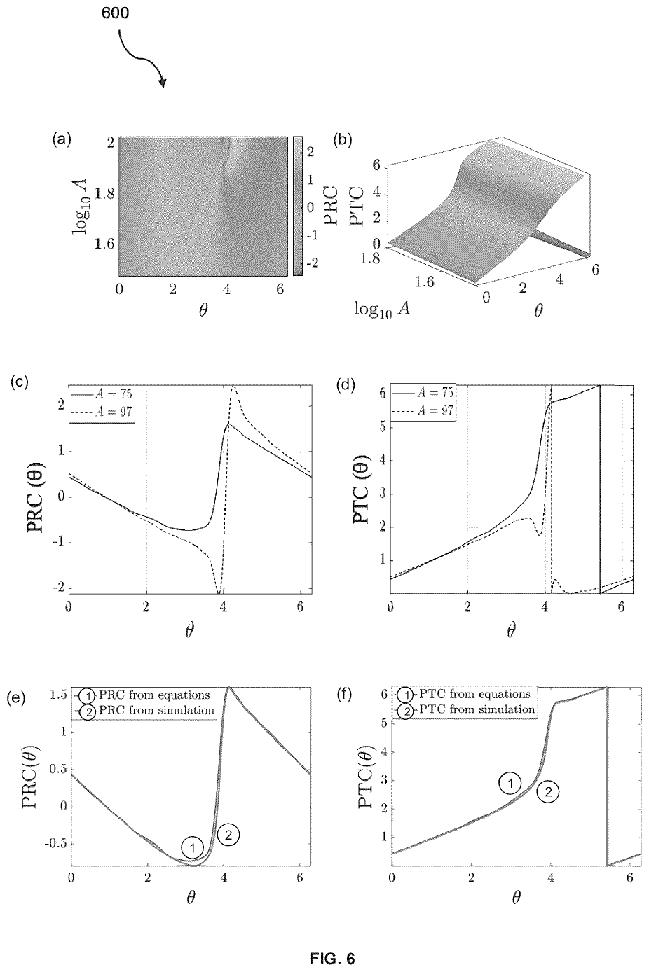

FIG. 6 illustrates an example graphical representation 600 of the Phase Response Curve (PRC) and the Phase Transition Curve (PTC) curves, according to an example. According to FIG. 6, the PRC, and the PTC curves for parameter values log₁₀ Q=1.44, K=0.5 may be depicted. Further, FIG. 6 illustrates following curves including, part (a) Generalized PRC, part (b) Generalized PTC (time Crystal), part (c) and part (d) PRCs and PTCs for weak and strong forcing, part (e) and part (d) PRC and PTC for A=75 as obtained from the mathematical model given by equation 1 and via conventional Simulink simulations. Further, the structure of the isochrons in the state space may determine the phase response of the oscillator as fully described by the generalized PRC and PTC may be illustrated in part (a) and part (b) of FIG. 6. Furthermore, characteristic PRCs and PTCs for moderate A=75 and strong A=97 forcing may be illustrated in part (c) and part (d) of FIG. 6. Furthermore, in the case where A=75, the Phase Response Curve (PRC) may be continuous, and the Phase Transition Curve (PTC) may be monotonic, which may preserve the orientation of the mapping and thus corresponds to a Type 0 curve. However, orientation may not be preserved in the case of strong forcing, corresponding to a Type 1 curve. Furthermore, the PRCs and PTCs as calculated from the mathematical model given by equation 1 and the conventional Simulink model may be compared and shown in agreement in part (e) and part (f) of FIG. 6. Furthermore, even the small discrepancies between the two curves may not actually compromise the application of the phase reduction method, as at least one of them may be used for the study of the synchronization dynamics and the phase-locking conditions. Furthermore, as calculations based on equation 1 may be less computational time consuming, may be used as a very accurate approximation for identifying the phase-locking regions in extended parameter scans, and the more realistic and time-consuming calculations based on the conventional Simulink and other realistic model may be used, if necessary, when focusing in a specific region of resonance diagram.

FIG. 7 illustrates an example graphical representation 700 of resonance diagram for the Colpitts oscillator, devil's staircase for moderate and strong forcing, according to an example. According to part (a), part (b) and part (c) of FIG. 7 resonance diagram for the Colpitts oscillator, Devil's staircase for moderate (A=75,type 0 PRC) and strong (A=97, type 1 PRC) forcing may be depicted. Further, the rotation number ρ(s; A) may not continuously be increasing for Type 1 curves. Furthermore, parameter values log₁₀ g=1.18, log₁₀ Q=1.44, K=0.5 may be taken. Furthermore, the resonance diagram with the characteristic Arnold tongues may be depicted in part (a) of FIG. 7. Furthermore, the rotation number as a function of s for a given forcing amplitude A has the characteristic form of a “Devil's staircase” of the conventional system as shown in part (b) of FIG. 7 with the regions of s with a constant rational value corresponding to the various orders of phase-locking. Furthermore, the difference between Type 0 and Type 1 curves manifests in the Devil's staircase as p not being increasing with respect to s.

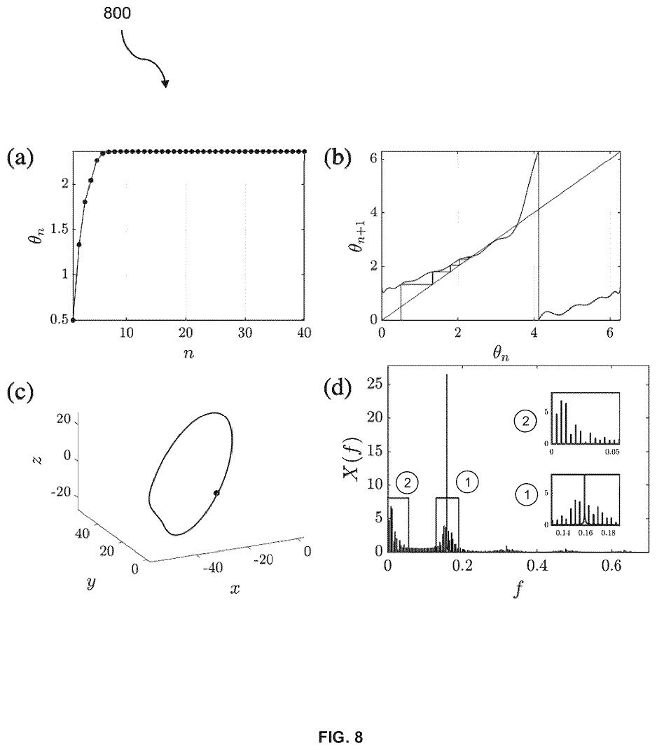

FIG. 8 illustrates an example graphical representation 800 of a circle map orbit, a cobweb plot, a limit cycle, and fixed point of the Poincare map derived from simulation of the system 114, and an output spectrum, according to an example. According to FIG. 8, part (a) depicts a Circle map orbit, part (b) depicts corresponding cobweb plot, part (c) depicts Limit cycle and fixed point of the Poincare map derived from simulation of the system 114, and part (d) depicts Output spectrum X(f)=| [symbol] (x(t))|. Further, the frequency spacing equals 1/(k+s) T. Furthermore, forcing parameters may include A=75, s=0.1, k=60.1:1 cycle. Circuit parameters: log₁₀ g=1.18, log₁₀ Q=1.44, K=0.5. Furthermore, based on the resonance diagram in FIG. 7, the perturbation parameters may be selected as s=0.1 and A=75, which may lie within the 1:1 resonant Arnold tongue. Furthermore, two identical Colpitts oscillators using the forcing described in equation (10) with k=60 may be perturbed. Furthermore, the synchronization dynamics may be studied by iterating the one-dimensional circle map of equation (14) with the utilization of the calculated PRC of part (c) of FIG. 6. Furthermore, the exponential convergence to the stable fixed point of the circle map corresponding to the phase-locked state may be depicted in FIG. 8 part (a) and part (b). Furthermore, the location of the stable fixed point corresponding to the final constant phase difference with respect to the incoming periodic signal may be shown in FIG. 8 part (c). Furthermore, in order to confirm that the circle map may provide the right conditions for phase-locking for the original three-dimensional system, an output spectrum 1 and an output spectrum 2 of the system variable x(t) may be depicted in FIG. 8 part (d). Furthermore, the discrete spectrum may be shown to consist of equidistant spectral lines with a spacing equal to 1/(k+s)T confirming the periodicity of the output and the phase-locking of the system 114. Furthermore, the differences in calculations based on equation (1) and the conventional Simulink model, in the diagrams depicted in FIG. 7 and FIG. 8, are hardly visible.

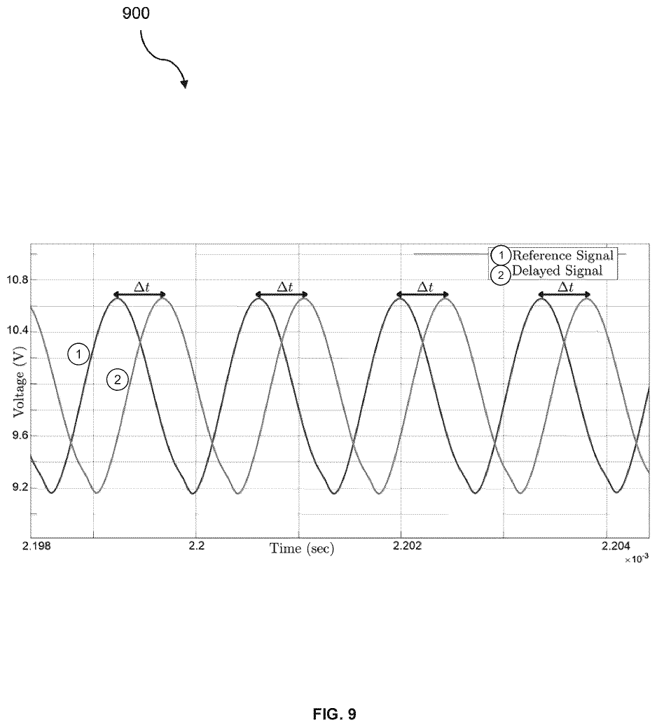

FIG. 9 illustrates an example graphical representation 900 of time series of the voltages in oscilloscope of the system 114, according to an example. According to FIG. 9, time series of the voltages v_{c1} in oscilloscope. Further, time difference Δ Δt=0.32T=440 ns. Furthermore, measurement error 1.12 ps. Furthermore, Table III may depict time delay and distance error over ten measurements using the synchronized oscillator.

TABLE III
Time delay and distance error over ten measurements
using the synchronized oscillator.

| | Absolute Time | Absolute Distance | Relative |
|---|---|---|---|
| Statistic | Error (ps) | Error (mm) | Error |
| Maximum | 1.12 | 0.33 | 8 × 10⁻⁶ |
| Value | | | |
| Minimum | 5 × 10⁻⁶ | 2 × 10⁻⁶ | 4 × 10⁻¹¹ |
| Value | | | |
| Mean | 0.43 | 0.13 | 3.1 × 10⁻⁶ |
| Value | | | |
| Std | 0.37 | 0.11 | 2.7 × 10⁻⁶ |

Additionally, under these phase-locking conditions the relative time delay Δt between the two oscillators may be readily measured, as shown in FIG. 9, to calculate the relative distance Δd=d2−d1=cΔt, where c is the speed of light. Further, to measure the time delay, the bandpass filter 202 may be used with a central frequency equal to the frequency of the locked oscillators, namely 1/(k+s)T, which may extract the Fourier coefficient at this harmonic. Furthermore, the difference between the arguments of the coefficients of the two synchronized oscillators may correspond to the desired phase difference, which is then converted to the relative time delay.

Furthermore, Table III may show the errors in estimating the time delay and relative distance across ten measurements, using random ground truth values. Furthermore, the sources of the small, reported errors may be primarily due to finite numerical accuracy and deviations in parameter values resulting from nonidealities. Furthermore, the central frequency of the bandpass filter 202 used to measure the phase difference between the two signals may be selected to match the frequency of the synchronized oscillator when all elements are ideal. However, in practical calculations, small errors may be induced. Further, a secondary source of error may be due to the finite time of the time-delay measurement. Furthermore, theoretically, an infinite time may be required, as the circle map may converge asymptotically to the fixed point corresponding to the phase locking state. However, this convergence may be exponential, as also shown in part (a) of FIG. 8, so that the error decreases rapidly for increasing time interval of measurement and its practical importance may be negligible.

Furthermore, in the simulation, only a finite time interval of NTᵢₙ, with N=35 may be used and let the oscillators evolve autonomously. Furthermore, a theoretical source of error may be related to the relative tolerance of the order 10-10 used in the numerical calculations. Furthermore, the time interval required for phase locking may determine the update rate of the position calculation Tᵤₚ=N(k+s) T, which has the value of 2.89 ms for the specific parameter values. Furthermore, the required values for k and N, determining Tᵤₚ, depend on the exponential convergence rates of a perturbed initial conditions to the limit cycle and the convergence to the fixed point of the circle map, respectively. Furthermore, these values may be further reduced drastically by optimizing with respect to the selection of the parameters of the oscillator determining the period and the convergence rate to the stable limit cycle as well as the selection of the stable phase-locked state. Furthermore, the aforementioned features may suggest an efficient time and distance measuring mechanism that may be appropriately tuned to a wide variety of timing and positioning applications, under judicious design and parameter selection. Furthermore, a reference signal 1 and a delayed signal 2 may be illustrated in FIG. 9.

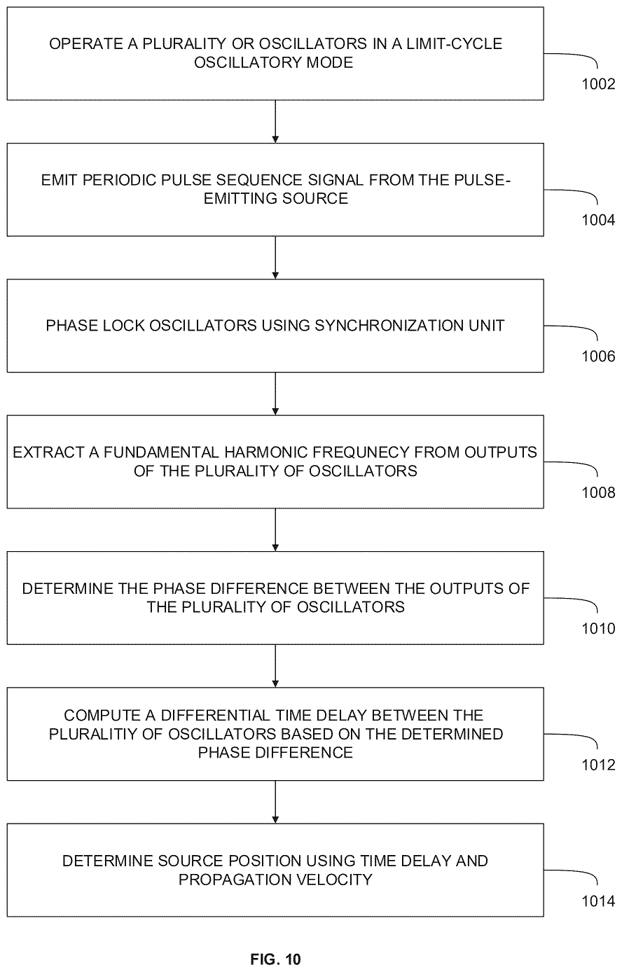

FIG. 10 illustrates an example flow diagram representation of a method for positioning and navigating objects using phase-synchronized nonlinear oscillators, according to an example. The disclosed method 1000 may be performed by one or more components of the synchronization unit 108 disclosed herein. For example, with reference to FIG. 2, the steps disclosed herein may be performed by the processing unit 106 (interchangeably used as the processor).

At block 1002, the method 1000 may include operating, by the processor 106, a plurality of oscillators 104 in a limit-cycle oscillatory mode. Each of the plurality of oscillators 104 is located at a plurality of spatial positions with respect to a pulse-emitting source 102.

At block 1004, the method 1000 may include emitting, by the pulse-emitting source 102, a periodic pulse sequence signal. The periodic pulse sequence signal propagates to each of the plurality of oscillators 104 with a respective time delay based on corresponding distances of the plurality of oscillators 104 from the pulse-emitting source 102.

At block 1006, the method 1000 may include phase-locking, by a synchronization unit 108 of a processing unit 106, each of the plurality of oscillators 104 to the periodic pulse sequence signal. Each of the plurality of oscillators 104 includes a phase difference proportional to a time delay of the periodic pulse sequence signal.

At block 1008, the method 1000 may include extracting, by a phase comparison unit 110 operatively connected to the output of the plurality of oscillators 104, a fundamental harmonic frequency from outputs of the plurality of oscillators 104 using a bandpass filter 202. The bandpass filter 202 is centered at a frequency corresponding to a synchronized oscillator frequency.

At block 1010, the method 1000 may include determining, by the phase comparison unit 110, the phase difference between the outputs of the plurality of oscillators 104 based on the extracted fundamental harmonic frequency.

At block 1012, the method 1000 may include computing, by a time delay computation unit 112 of the processing unit 106, a differential time delay between the plurality of oscillators 104 based on the determined phase difference.

At block 1014, the method 1000 may include determining, by the time delay computation unit 112, a position of the signal-emitting pulse-emitting source 102 by converting the time delays into a relative spatial distance using a predefined propagation velocity of the periodic pulse sequence signal.

In an example, the method 1000 may include phase-locking each of the plurality of oscillators 104 including deriving, by the synchronization unit 108 of the processing unit 106, a phase response characteristic and a phase transition characteristic for each of the plurality of oscillators 104 using a mathematical model. The mathematical model defines a limit cycle and isochrons in a state space of the plurality of oscillators 104. Further, the method 1000 may include evaluating, by the synchronization unit 108 of the processing unit 106, synchronization parameters of each of the plurality of oscillators 104 based on the phase response characteristic to identify regions of phase-locking within a resonance diagram. Further, in the system 114 may refer to timing and forcing parameters, which may be used in defining the external periodic pulse sequence and interaction of the external periodic pulse sequence with the oscillators. Furthermore, a base period of the external periodic pulse sequence may be represented as ‘T’. Furthermore, ‘T’ may be a fundamental time interval between successive pulses emitted by the source. Furthermore, ‘T’ may set the temporal scale of the forcing and affects the frequency of the signal. Furthermore, an Integer multiple of the period may be represented by ‘k’. Furthermore, ‘T’ may be used for defining synchronization intervals. Furthermore, synchronization intervals may represent number of base periods, which may be used to compute one full cycle of interest including but not limited to over which phase-locking may be evaluated. Furthermore, synchronization intervals may be used to scale up the time window for phase measurement and filtering. Furthermore, fractional shift and delay component added to the integer multiple may be represented by ‘s’. Furthermore, the fractional shift and delay component added to the integer multiple may allow fine adjustment of the synchronization window or filtering frequency. Furthermore, expression (k+s) T, may define the effective periodicity of the locked system and the central frequency, which may be used for filtering.

Additionally, the method 1000 may include performing, by the synchronization unit 108 of the processing unit 106, phase-locking to each of the plurality of oscillators 104 by iteratively aligning the phase of the plurality of oscillators 104 with the periodic pulse sequence signal using a circle map constructed from the phase response characteristic.

In an example each of the plurality of oscillators 104 may correspond to a Colpitts oscillator modelled by a nonlinear system of differential equations

In an example, to determine the phase difference, the method 1000 may include computing, by the phase comparison unit 110, complex Fourier coefficients at fundamental frequencies of each of the output of the oscillators. Further, the method 1000 may include calculating, by the phase comparison unit 110, phase angle differences between each of the complex Fourier coefficients.

In an example, to compute the differential time delay, the method 1000 may include converting, by the processor 106, the determined phase difference into a time delay by scaling an angular difference by an inverse of a fundamental frequency corresponding to output of each oscillator 104.

In an example, to phase-lock each of the plurality of oscillators 104, the method 1000 may include determining, by the synchronization unit 108, phase errors during synchronization by analyzing convergence of a phase trajectory of the oscillator 104 to a stable phase-locked state. Further, the method 1000 may include selecting, by the synchronization unit 108, a measurement interval for synchronization based on the determined phase errors. Furthermore, the method 1000 may include optimizing, by the synchronization unit 108, oscillator parameters and periodic signal characteristics based on the selected measurement interval. Furthermore, the periodic signal characteristics comprise a pulse amplitude, a duty cycle, and a frequency.

In an example, to phase-lock each of the plurality of oscillators 104, the method 1000 may include adjusting, by the synchronization unit 108, parameters of the periodic pulse sequence signal to remain within a synchronization region for phase-locking. The parameters include a pulse amplitude, a duty cycle, and a frequency.

In an example, the method 1000 may include, validating, by the processor 106, an oscillator model and a synchronization behavior of the oscillator model using a simulation environment. The simulation environment replicates real-world electrical conditions. Further, the simulation environment includes non-ideal component characteristics comprising a parasitic resistance, a parasitic inductance, and a parasitic capacitance.

The order in which the method 1000 is described is not intended to be construed as a limitation, and any number of the described method blocks may be combined or otherwise performed in any order to implement the method 1000 or an alternate method. Additionally, individual blocks may be deleted from the method 1000 without departing from the spirit and scope of the ongoing description. Furthermore, the method 1000 may be implemented in any suitable hardware, software, firmware, or a combination thereof, that exists in the related art or that is later developed. The method 1000 describes, without limitation, the implementation of the network environment 100. A person of skill in the art will understand that method 1000 may be modified appropriately for implementation in various manners without departing from the scope and spirit of the ongoing description.

In an example, the system 114 may use a mechanism through exploiting the dynamical properties of a nonlinear plurality of electronic oscillators (interchangeably referred to as the plurality of oscillators 104), which may determine response to external stimulations, in order to measure the time delay between signals arriving at the plurality of oscillators 104 anchored in different spatial positions. Further, in the case of a signal broadcasted from an object with unknown location, the time delays between the anchored oscillators 104 may be used for its accurate positioning. Furthermore, the present disclosure may use advanced mathematical methods for the study of complex synchronization dynamics and phase-locking, originally used in the context of mathematical biology including but not limited to heart pacemakers and computational neuroscience.

In an example, the phase locking of an electronic limit-cycle oscillator to an external periodic pulse sequence may be a complex process, which may depend crucially on the parameters of the free-running oscillator including but not limited to PRC and PTC as well as on the characteristics of the external signal. Further, the method of phase reduction may be applied to the plurality of electronic oscillators 104, namely the Colpitts oscillator. Furthermore, the robustness of the method 1000 may be demonstrated by the utilization of a differential equation model of the network environment 100, as well as a Simulink model with non-ideal parameters resembling an experimental set up.

Furthermore, the network environment 100 may determine phase-locking conditions, which may be used for the operation of more than two of the Colpitts oscillators 104 acted upon by the same periodic pulse sequence emitted by the same source 102 and arrived at each one of them at different time moments due to different distances from the source 102. Furthermore, the plurality of oscillators 104 may be phase locked to the incoming periodic signal but with a relative phase delay, which may be proportional to differential distance from the source allowing for precise positioning of the broadcasting object.

In an example, limit cycles and isochrons may be described. Further, a plurality of electronic circuits serving as clocks support self-sustained oscillations and correspond to dynamical systems possessing stable limit cycles. Furthermore, the periods of the limit cycles may be determined by the specific parameter values of the underlying model. Furthermore, stability of limit cycles may imply that, under any finite-time perturbation, the system 114 may finally relax exponentially on oscillatory state of the system 114. Furthermore, an archetypal mathematical model of a limit-cycle oscillator may be the Hopf oscillator, which may locally represent a large class of oscillators as normal form of the large class of oscillators may be given in polar coordinates.

$$\dot{r} = λ r ( 1 - {r}^{2} ) \qquad ( 6 )$$

Additionally, the system 114 has an unstable fixed point at the origin (r=0) and a limit cycle of unit radius (r=1) which is stable when λ>0. The magnitude of λ determines the convergence rate of initial conditions or perturbations to the stable limit cycle and ω is the frequency of the oscillatory state. The most popular simple model for an electronic circuit supporting stable limit cycles is the Van der Pol oscillator:

$$\dot{x} = y \qquad ( 7 )$$

$$\dot{y} = μ ( 1 - {x}^{2} ) y - x$$

Additionally, μ being a parameter indicating the nonlinear damping of a conventional system. Further, the Van der Pol oscillator, when operated at parameter values suggesting the existence of a stable limit cycle, has qualitatively similar dynamical properties with the Hopf oscillator and can be implemented by various electronic circuits. Furthermore, apart from specific shape of the limit cycles, characteristic frequency and convergence rate, a limit cycle may be characterized by accompanying isochrons' structure of the limit cycle, which may crucially determine the response of the system 114 to external perturbations and, therefore, synchronization with periodic inputs. Furthermore, as the system 114 evolves along a limit cycle, the phase of the oscillation θ∈[0,2π) may be readily defined, with an arbitrarily chosen point of zero phase. Furthermore, for every point within the basin of attraction of a stable limit cycle, is the subset of the state space where initial conditions converge to the limit cycle. Furthermore, the definition of the phase by assigning an asymptotic phase may be extended, which may be the relative phase of the asymptotic solution after the transient time required for converging to the limit cycle, corresponding to an initial condition. Furthermore, Isochrons may correspond to curves consisting of points with the same asymptotic phase, and isochrons may partition the entire basin of attraction of the limit cycle. Furthermore, the complement set of the basin of attraction in the state space may be the phase less set, which may consist solely of the origin. Furthermore, the structure of the isochrons may be characteristic for each oscillator. Furthermore, the structure of the isochrons may be determined by the form of the limit cycle and the phase less set. Furthermore, based on the structure of the isochrons, the Hopf oscillator may be referred to as a radial isochron clock, whereas the Van der Pol oscillator may be referred to as a general radial isochron clock, due to the curved form of isochrons.

In an example, phase response and time sensing may be described. Further, structure of the isochrons may crucially determine the response of the system 114 under an external stimulus. Furthermore, the application of a pulsed perturbation to the system 114 oscillating along a limit cycle moves the state of the system 114 to a new point in the state space. Furthermore, as the point may lie within the basin of attraction, the point may belong to a specific isochron, which may determine the asymptotic phase of the oscillation after relaxation of the system 114 to the stable limit cycle. Furthermore, the effect of the pulsed perturbation may be at least one of a phase advance and a delay with respect to the absence of perturbation. Furthermore, the Phase Transition Curve (PTC) and the Phase Response Curve (PRC) for a given perturbation strength A may be defined, respectively, as the new phase θ′ and the phase difference before and after a perturbing pulse, which may be applied when the oscillation phase may be θ as given in equation (8) and equation (9).

$$PTC ( θ ) = {θ}^{′} \qquad ( 8 )$$

$$PRC ( θ ) = {θ}^{′} - θ . \qquad ( 9 )$$

Additionally, the PTC and the PRC may be readily calculated in at least one of the following ways numerically and experimentally, by repeated measurements of the new phase of the oscillation after the application of the stimulating pulse at different phases of the oscillation. Further, in the case of experimental measurement, there may be no need for a specific mathematical model, and the method of phase reduction for the study of synchronization dynamics may be applied with the utilization of the experimentally obtained curves, therefore facilitating the consideration of the system 114. Furthermore, for the simplest Hopf oscillator model, the asymptotic phase function θ may be readily obtained analytically and expressed in equation (10).

$$θ ( r , ϕ ) = ϕ \qquad ( 10 )$$

Additionally, PRCs may be calculated analytically for arbitrary stimulation amplitudes. Further, for the case of a stimulus in the form of a Dirac delta function, depending on whether the stimulus perturbs the system 114 along the x or y Cartesian direction, the PRC may be defined as a two-component vector as given in equation (11), equation (12) and equation (13).

$$PRC ( θ , A ) = ( {PRC}_{x} ( θ , A ) , {PRC}_{y} ( θ , A ) ) \qquad ( 11 )$$

$$with$$

$$PR {C}_{x} ( θ , A ) = ( - 1 ) ⌈ 1 - \frac{sin θ}{2} ⌉ arccos ( \frac{1 + A cos θ}{\sqrt{1 + 2 A cos θ + {A}^{2}}} ) \qquad ( 12 )$$

$$PR {C}_{y} ( θ , A ) = ( - 1 ) ⌈ \frac{cos θ}{2} - 1 ⌉ arccos ( \frac{1 + A sin θ}{\sqrt{1 + 2 A sin θ + {A}^{2}}} ) \qquad ( 13 )$$

Further, where ┌·┐ may denote the ceiling function. Furthermore, PRCs and PTCs defined also as functions of the amplitude may be referred to as generalized PRCs and PTCs.

Additionally, depending on the amplitude A of the stimulation in comparison to the radius of the limit cycle (r=1) two qualitatively different types may be distinguished. Further, Type 1, for relatively weak amplitudes (A<1), resulting in continuous PRCs and monotonic PTCs with mean slope equal to one. Furthermore, Type 0, for relatively strong amplitudes (A>1), resulting in discontinuous PRCs and non-monotonic PTCs with mean slope equal to zero. Furthermore, the qualitative characteristics of the phase response of the simple Hopf oscillator under a Dirac delta function stimulation may be typical for all types of limit cycle oscillators, stimulated by pulses of finite duration having arbitrary forms, as may also be shown in a following section for the case of the Colpitts oscillator perturbed by a rectangular pulse. Furthermore, the phase response of a limit-cycle oscillator may be considered as the response function of a time sensor, according to which the occurrence time (clock phase θ) of an event (pulse) may be determined by at least one of the phase advancements and the delay (new phase θ′) of the clock, especially for the case of a one-to-one correspondence suggested by a monotonic PTC of Type 1.

In an example, phase reduction and complex synchronization dynamics of periodically driven electronic oscillators may be described. Further, a periodic sequence of pulsatile stimulations may lock an electronic oscillator to a constant phase with respect to the periodic sequence, which may be similar to the operation of a heart pacemaker and even drive the oscillator to a chaotic state. Furthermore, the phase response of the cycle oscillator, as described by the PRC and the PTC pulses. Furthermore, the period of the pulse sequence may be written as Tᵢₙ=(k+s)T, k∈ [symbol] , s∈[0,1), where T may be the period of the unforced limit cycle. Furthermore, under the assumption that the period of the incoming pulse sequence is large enough for the oscillator to relax on the stable limit cycle within the time interval between two subsequent pulses, which is a sufficiently large value of k, the complex synchronization dynamics may be accurately described in terms of a one-dimensional including but not limited to Poincare circle map described by equation (14).

$${θ}_{n + 1} = {θ}_{n} + PRC ( {θ}_{n} , A ) + 2 π s mod 2 π , \qquad ( 14 )$$

Furthermore, where θₙ may be the oscillation phase before the n-th stimulus. Furthermore, the drastic dimensional reduction may be described as phase reduction. Furthermore, phase reduction may be performed solely on the basis of at least one of a numerically and an experimentally obtained PRC, which may facilitate the application of the respective analysis to realistic including model free configurations. Furthermore, the seemingly simple circle map of equation (14) has a remarkably rich set of dynamical features. Furthermore, phase locking with respect to the periodic pulse sequence may correspond to fixed points of the map given from the equation (15).

$$PRC ( {θ}_{n} , A ) = 2 π ( 1 - s ) \qquad ( 15 )$$

Further, determining the margin for the detuning in order to achieve synchronization, and slope may determine the stability of the fixed point and the corresponding synchronized state as given in equation (16).

$$- 2 < {PRC}^{′} ( θ , A ) < 0 , \qquad ( 16 )$$

Furthermore, where prime may denote differentiation with respect to θ. Furthermore, the form of the generalized PRC and PTC, determining the synchronization properties of the reduced circle map and the system 114, for a Hopf and a Van der Pol oscillator with the generalized PTC also known as the time crystal of the limit-cycle oscillator. Furthermore, the minimum dimension and the simplicity of the circle map may facilitate the systematic numerical investigation of the synchronization properties of the system 114 in the parameter space of the periodic pulse sequence in a remarkably computationally efficient fashion. Furthermore, the rotation number ρ may express the average increase in the phase θ per iteration and may be defined as given in equation (17).

$$ρ = {lim}_{n \to ∞} \frac{{Θ}_{n} - {Θ}_{t}}{n - t} \qquad ( 17 )$$

Furthermore, where θ may be the lift of the asymptotic phase function θ to the real axis, and t may denote a number of excluded initial (transient) iterations. Furthermore, a zero value of the rotational number (ρ=0) may indicate a one-to-one phase locking with the periodic pulse sequence, where the frequency of the oscillator precisely matches that of the external force. Furthermore, in contrast, non-zero rational values of the rotation number (ρ=p/q∈ [symbol] ) may correspond to higher-order synchronization. Furthermore, here p may denote the number of cycles completed by the oscillator, while q denotes the number of cycles of the external force. Furthermore, the phase-locking regions may emanate from rational points of the horizontal including zero amplitude axis and form the well-known Arnold tongues. Furthermore, the dynamics within the Arnold tongues as well as the bifurcations taking place at respective boundaries depend crucially on the forcing amplitude determining whether corresponding to at least one of a Type-1 and a Type-0 stimulation. Furthermore, for relatively small amplitudes, the dynamics may be uniquely determined by the rotation number, whereas for larger amplitudes bifurcations leading to chaotic evolution may take place without any change in the rotation number.

Various examples of systems and methods for high-precision positioning using synchronized nonlinear oscillators, may be provided. Various example implementations of the disclosed approach herein may provide for systems and methods for determining time delays and spatial positions using synchronized nonlinear electronic oscillators.

Various examples of systems and methods for high-precision positioning using synchronized nonlinear oscillators, may be provided. Various example implementations of the disclosed approach herein may provide a method for high-precision timing and positioning, based on the phase response and the synchronization dynamics of driven nonlinear electronic oscillators. Further, the plurality of oscillators 104, supporting self-sustained oscillations and serving as clocks, may be uniquely characterized by phase response under an external stimulus enabling operation of the plurality of oscillators 104 as time sensors. Furthermore, the plurality of oscillators 104 may provide phase response depending crucially on the characteristic isochron structure of the underlying limit cycle. Furthermore, the plurality of oscillators may determine conditions for phase-locking to a received periodic pulse sequence. Furthermore, under such conditions for a number of identical oscillators located at different positions, each oscillator may be locked to a constant phase difference with respect to a received input signal, which may enable the precise measurement of the differential time delay between a signal emitted from a source. Therefore, the plurality of oscillator may provide a precise positioning. Furthermore, the method presented for archetypical as well as practical electronic circuits, such as the Colpitts oscillator, may be shown to be robust, precise, and applicable to any type of electronic oscillator.

Various examples for high-precision positioning using synchronized nonlinear oscillators, may be provided. Various example implementations of the disclosed approach herein may provide that the method for a high-precision time and position measurement, which may be based on the phase response of the electronic oscillators and complex synchronization dynamics under external driving by received signal. Furthermore, the method may measure the time delay between two or more signals under well-defined conditions for phase-locking, which may enable high-precision positioning.

Various examples of systems and methods for high-precision positioning using synchronized nonlinear oscillators, may be provided. Further, the system overcomes the problem of the phase locking of an electronic limit-cycle oscillator to an external periodic pulse sequence, which may be a complex process depending crucially on the parameters of the free-running oscillator (PRC/PTC) as well as on the characteristics of the external signal. Furthermore, the systems and methods for high-precision positioning using synchronized nonlinear oscillators may use phase reduction to one of the most popular and widely used electronic oscillators, namely the Colpitts oscillator. The robustness of the method is demonstrated by the utilization of a differential equation model of the system, as well as a Simulink model with non-ideal parameters resembling an experimental set up. Furthermore, the method may determine phase-locking conditions, which may be used for the operation of above two Colpitts oscillators acted upon by the same periodic pulse sequence emitted by the same source and arrived at each one of them at different time moments due to different distances from the source. Furthermore, the plurality of oscillators may be phase locked to the incoming periodic signal however with a relative phase delay which may be proportional to differential distance of the plurality of oscillator from the source, allowing for precise positioning of the broadcasting object.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing network communication.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

It should be appreciated that the systems and methods described herein may also be used to help provide, directly or indirectly, measurements for distance, angle, rotation, speed, position, wavelength, transmissivity, and/or other related tests and measurements.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims—and their equivalents—in which all terms are meant in their broadest reasonable sense unless otherwise indicated.

1. A system, comprising:
a plurality of oscillators to operate in a limit-cycle oscillatory mode, and wherein each of the plurality of oscillators are located at a plurality of spatial positions with respect to a pulse-emitting source;
the pulse-emitting source to emit a periodic pulse sequence signal, wherein the periodic pulse sequence signal propagates to each of the plurality of oscillators with a respective time delay based on corresponding distances of the plurality of oscillators from the pulse-emitting source;
a processing unit comprising:
a synchronization unit to phase-lock each of the plurality of oscillators to the periodic pulse sequence signal, wherein each of the plurality of oscillators comprises a phase difference proportional to a time delay of the periodic pulse sequence signal;
a phase comparison unit operatively connected to the output of the plurality of oscillators, wherein the phase comparison unit is to:
extract a fundamental harmonic frequency from outputs of the plurality of oscillators using a bandpass filter, wherein the bandpass filter is centered at a frequency corresponding to a synchronized oscillator frequency; and
determine the phase difference between the outputs of the plurality of oscillators based on the extracted fundamental harmonic frequency; and
a time delay computation unit to:
compute a differential time delay between the plurality of oscillators based on the determined phase difference; and
determine a position of the pulse-emitting source by converting the time delays into a relative spatial distance using a predefined propagation velocity of the periodic pulse sequence signal.

2. The system of claim 1, wherein the synchronization unit is to determine phase-locking conditions of each of the plurality of oscillators by:
deriving a phase response characteristic and a phase transition characteristic for each of the plurality of oscillators using a mathematical model, wherein the mathematical model defines a limit cycle and isochrons in a state space of the plurality of oscillators;
evaluating synchronization parameters of each of the plurality of oscillators based on the phase response characteristic to identify regions of phase-locking within a resonance diagram; and
performing phase-locking to each of the plurality of oscillators by iteratively aligning the phase of the plurality of oscillators with the periodic pulse sequence signal using a circle map constructed from the phase response characteristic.

3. The system of claim 2, wherein the phase response characteristic comprises a phase response curve and a phase transition curve, wherein the phase response curve being continuous for moderate forcing.

4. The system of claim 1, wherein each of the plurality of oscillators correspond to a Colpitts oscillator modelled by a nonlinear system of differential equations.

5. The system of claim 4, wherein the Colpitts oscillator comprises a time-dependent current source with a normalized amplitude connected in parallel with a constant current source, and a resistor for optimizing ohmic losses of an inductor.

6. The system of claim 1, wherein each Colpitts oscillator comprises a transistor-based amplifier stage, a split capacitive voltage divider, and an inductive feedback loop forming an LC tank circuit.

7. The system of claim 1, wherein the periodic pulse sequence signal comprises a sequence of rectangular pulses with a unitary amplitude, a pulse width proportional to a fraction of period of an unforced limit cycle of the plurality of oscillators, and a period defined as a multiple of the unforced limit cycle period adjusted by a fractional parameter.

8. The system of claim 1, wherein the phase comparison unit is to compute complex Fourier coefficients at fundamental frequencies of each of the output of the oscillators and calculate phase angle differences between each of the complex Fourier coefficients.

9. The system of claim 1, wherein the time delay computation unit is to convert the determined phase difference into a time delay by scaling an angular difference by an inverse of a fundamental frequency corresponding to output of each oscillator.

10. The system of claim 1, wherein the synchronization unit is to:
determine phase errors during synchronization by analyzing convergence of a phase trajectory of the oscillator to a stable phase-locked state;
select a measurement interval for synchronization based on the determined phase errors; and
optimize oscillator parameters and periodic signal characteristics based on the selected measurement interval, wherein the periodic signal characteristics comprise a pulse amplitude, a duty cycle, and a frequency.

11. The system of claim 1, wherein the synchronization unit is to adjust parameters of the periodic pulse sequence signal to remain within a synchronization region for phase-locking, wherein the parameters comprise a pulse amplitude, a duty cycle, and a frequency.

12. The system of claim 1, wherein the processing unit is to:
validate an oscillator model and a synchronization behavior of the oscillator model using a simulation environment, wherein the simulation environment replicates real-world electrical conditions, and wherein the simulation environment comprises non-ideal component characteristics comprising a parasitic resistance, a parasitic inductance, and a parasitic capacitance.

13. A method comprising:
operating a plurality of oscillators in a limit-cycle oscillatory mode, wherein each of the plurality of oscillators is located at a plurality of spatial positions with respect to a pulse-emitting source;
emitting, by the pulse-emitting source, a periodic pulse sequence signal, wherein the periodic pulse sequence signal propagates to each of the plurality of oscillators with a respective time delay based on corresponding distances of the plurality of oscillators from the pulse-emitting source;
phase-locking, by a synchronization unit of a processing unit, each of the plurality of oscillators to the periodic pulse sequence signal, wherein each of the plurality of oscillators comprises a phase difference proportional to a time delay of the periodic pulse sequence signal;
extracting, by a phase comparison unit operatively connected to the output of the plurality of oscillators, a fundamental harmonic frequency from outputs of the plurality of oscillators using a bandpass filter, wherein the bandpass filter is centered at a frequency corresponding to a synchronized oscillator frequency;
determining, by the phase comparison unit, the phase difference between the outputs of the plurality of oscillators based on the extracted fundamental harmonic frequency;
computing, by a time delay computation unit of the processing unit, a differential time delay between the plurality of oscillators based on the determined phase difference; and
determining, by the time delay computation unit, a position of the signal-emitting pulse-emitting source by converting the time delays into a relative spatial distance using a predefined propagation velocity of the periodic pulse sequence signal.

14. The method of claim 13, wherein phase-locking each of the plurality of oscillators comprises:
deriving, by the synchronization unit of the processing unit, a phase response characteristic, and a phase transition characteristic for each of the plurality of oscillators using a mathematical model, wherein the mathematical model defines a limit cycle and isochrons in a state space of the plurality of oscillators;
evaluating, by the synchronization unit of the processing unit, synchronization parameters of each of the plurality of oscillators based on the phase response characteristic to identify regions of phase-locking within a resonance diagram; and
performing, by the synchronization unit of the processing unit, phase-locking to each of the plurality of oscillators by iteratively aligning the phase of the plurality of oscillators with the periodic pulse sequence signal using a circle map constructed from the phase response characteristic.

15. The method of claim 13, wherein each of the plurality of oscillators correspond to a Colpitts oscillator modelled by a nonlinear system of differential equations.

16. The method of claim 13, wherein determining the phase difference comprises:
computing, by the phase comparison unit, complex Fourier coefficients at fundamental frequencies of each of the output of the oscillators; and
calculating, by the phase comparison unit, phase angle differences between each of the complex Fourier coefficients.

17. The method of claim 13, wherein computing the differential time delay comprises:
converting the determined phase difference into a time delay by scaling an angular difference by an inverse of a fundamental frequency corresponding to output of each oscillator.

18. The method of claim 13, wherein phase-locking each of the plurality of oscillators further comprises:
determining, by the synchronization unit, phase errors during synchronization by analyzing convergence of a phase trajectory of the oscillator to a stable phase-locked state;
selecting, by the synchronization unit, a measurement interval for synchronization based on the determined phase errors; and
optimizing, by the synchronization unit, oscillator parameters and periodic signal characteristics based on the selected measurement interval, wherein the periodic signal characteristics comprise a pulse amplitude, a duty cycle, and a frequency.

19. The method of claim 13, wherein phase-locking each of the plurality of oscillators comprises:
adjusting, by the synchronization unit, parameters of the periodic pulse sequence signal to remain within a synchronization region for phase-locking, wherein the parameters comprise a pulse amplitude, a duty cycle, and a frequency.

20. The method of claim 13, further comprising:
validating, by the processing unit, an oscillator model and a synchronization behavior of the oscillator model using a simulation environment, wherein the simulation environment replicates real-world electrical conditions, and wherein the simulation environment comprises non-ideal component characteristics comprising a parasitic resistance, a parasitic inductance, and a parasitic capacitance.
